(19) United States
(12) Patent Application Publication
(10) Pub. No.: US 2010/0070088 A1
(43) Pub. Date: Mar. 18, 2010

(54) AIR-CONDITIONING ALGORITHM FOR WATER TERMINAL FREE COOLING

(75) Inventors: Olivier Josserand, La Boisse (FR); Eric Royet, Thil (FR); JeanPhilippe Goux, Toussieu (FR); Patrick Renault, Lyon (FR)

Correspondence Address: MARJAMA MULDOON BLASIAK & SULLIVAN LLP, 250 SOUTH CLINTON STREET, SUITE 300, SYRACUSE, NY, 13202, US

(73) Assignee: CARRUER CORPORATION, Farmington, CT (US)

(21) Appl. No.: 12/521,472

(22) PCT Filed: Dec. 29, 2006
(86) PCT No.: PCT/US06/49628

§ 371 Date: Nov. 24, 2009

(51) Int. Cl. G05D 23/19

(52) U.S. Cl. 700/277

(57) ABSTRACT

A building air conditioning system control scheme to optimize water terminal capacity and create energy savings by utilizing a building management system signal to run in a mode that maximizes the conditions of the outside air to condition their local zones and potentially require no thermal pre-treatment of outside air by an air handling unit.

### CROSS REFERENCE TO RELATED APPLICATIONS

This application is related to another patent application identified by Attorney docket number 210-1050PCT. Both are subject to assignment to Carrier Corporation and each is being filed on an even date herewith.

### FIELD OF THE INVENTION

The present invention is related to air-conditioning systems, and more particularly to an algorithm to optimize the free cooling mode related to controllers and systems driving hydronic products such as water terminals and, air handling units.

### BACKGROUND OF THE INVENTION

Usually, commercial building hydronic air-conditioning systems are made of one or more chillers or heat pumps that produce cooling and/or heating water, several water terminals, also referred to as fan coil units, and one or more air handling units that supply fresh air to the building through a duct network in order to maintain a minimum Indoor Air Quality (IAQ) for the comfort of building occupants. Some of these air handlers are energy recovery ventilation systems.

In normal operation, coolant fluid, usually cooling and/or heating water, possibly having additives, is distributed through a pipe network from the air handling units to the local zone water terminals where it is circulated within a local zone temperature adjusting coil. Additionally, the air handling unit performs IAQ functions such as purification, filtration, or fresh air flow management. With the appropriate coolant fluid at the water terminal, its fan pushes air through its coil to condition it as needed to provide personalized local comfort such as cooling, accomplished by passing cool coolant fluid through the coil, or heating, accomplished by passing heated coolant fluid through the coil.

Usually there is one water terminal per working zone, for example, an office space, meeting room, or washroom, with each having their own local water terminal and water terminal controller. Typically, a water terminal controller is connected to a local user interface that allows for temperature selection and fan speed control. Many local zone temperature controllers are capable of being connected to a building air-conditioning system communication network enabling multiple components of the entire building air-conditioning system to communicate with each other or be monitored or controlled by a building management system that is also connected to the building air-conditioning communication network.

In usual operation, the outside air is aspirated by the air handling unit, then filtered and thermally treated (cooled or heated depending on the need) by its coil where the coolant fluid is circulated. The coil is equipped with a proportional coolant flow valve that opens or closes the coolant fluid pipe and therefore enables or disables the heat transfer. After treatment in the air handling unit, the “fresh” supply air is blown through a network of ducts to all the local zone water terminals through fresh air dampers that control the fresh airflow, usually depending on the demand. The water terminals control their own proportional coolant flow valve to provide the demanded comfort inside the controlled zone.

The outside air is conditioned in the air handler units to a level where each water terminal will have the capacity to condition it locally as needed to provide the air-conditioning required by the zone user. If the local water terminal does not have the capacity to meet the requirements of the zone, their controls open their local fresh air damper to receive the air in the ductwork that was pre-conditioned by the air handling unit. However, this control scheme does not take advantage of information relating to the condition of the outside air to create energy savings.

Other systems in use do not have an air handler but simply have a fan and a filter to provide fresh air flow into the building. Therefore, there is no thermal pre-treatment of the fresh air, and the water terminals control the temperature of their zones using the outside fresh air as needed without regard for the outside air temperature.

This is problematic because achievement of the desired zone temperature may be beyond the capacity of the water terminal because the outside air temperature is largely different than the zone setpoint and opening the fresh air damper may result in a change in zone temperature that is even further away from the setpoint.

In advanced technology water terminals such as demand control ventilation systems, the exact amount of fresh air needed to maintain a minimum IAQ is determined by a system that senses the level of carbon dioxide and its dilution in the zone. Typically, the carbon dioxide detection system includes a carbon dioxide sensor that communicates with a carbon dioxide controller which deduces presence or absence of humans in the zone. Based on this dilution level and the minimum IAQ, the aperture of the fresh air intake damper is adjusted to reduce the carbon dioxide level in the zone. In some cases, the resultant air flow information is returned to the local water terminal controller or to a building management system which might control a system through a physical communication bus or other remote communication technology.

While most systems use the local water terminal controller to control the air temperature, and the carbon dioxide system to control the carbon dioxide dilution in the zone by actuating their fresh air dampers, they do not employ additional sensors or controls to optimize the system by making full use of the combined information relating to the carbon dioxide dilution and outside air conditions.

### SUMMARY OF THE INVENTION

An air-conditioning system control scheme is provided for implementation in local water terminals of a building air conditioning system wherein each water terminal can receive a command from a building management system to run in a variety of modes to achieve energy savings and increased water terminal cooling capacity. These modes are dependent on the temperature of the outside air measurement provided to the building management system, the local zone temperature setpoints, and the human occupancy of the air-conditioned zone.

Where the outside air is of a temperature to entirely satisfy the air-conditioning demand of the zone with no thermal pre-treatment of the air by the air handling unit, the zone is said to be in free cooling mode. There are two modes within which to run free cooling. One is when the air-conditioned zone is occupied by humans, and the other is when the air-conditioned zone is not occupied by humans.

Where the outside air is of a temperature to partially satisfy the air-conditioning demand of the zone with no thermal pre-treatment of the air by the air handling unit, the zone is said to be in pre-free cooling mode. Pre-free cooling mode is only available when the zone is unoccupied.

In one embodiment, a new water terminal control scheme achieves energy savings and free cooling of a building zone by accepting a command from a building management system to run in the free cooling mode.

In another embodiment, a new water terminal control scheme achieves energy savings and pre-free cooling of a building zone by accepting a command from a building management system to run in the pre-free cooling mode.

### BRIEF DESCRIPTION OF THE DRAWINGS

For a further understanding of these and other objects of the invention, reference will be made to the following detailed description of the invention which is to be read in connection with the accompanying drawing, where:

FIG. 1 diagrammatically depicts an air handling unit and a connection to an exemplary water terminal wherein the controllers of both are connected to a building communication network that includes a Building Management System; and

FIG. 2 depicts a block diagram of the new water terminal control algorithm to illustrate programmable and sensor signals to the water terminal controller and signals to various mechanical components of the water terminal.

FIG. 3 is a depiction of the operation of the new water terminal control algorithm operating in free cooling mode in the occupied mode; and

FIG. 4 is a depiction of the operation of the new algorithm operating in free cooling mode in the unoccupied mode.

### DETAILED DESCRIPTION

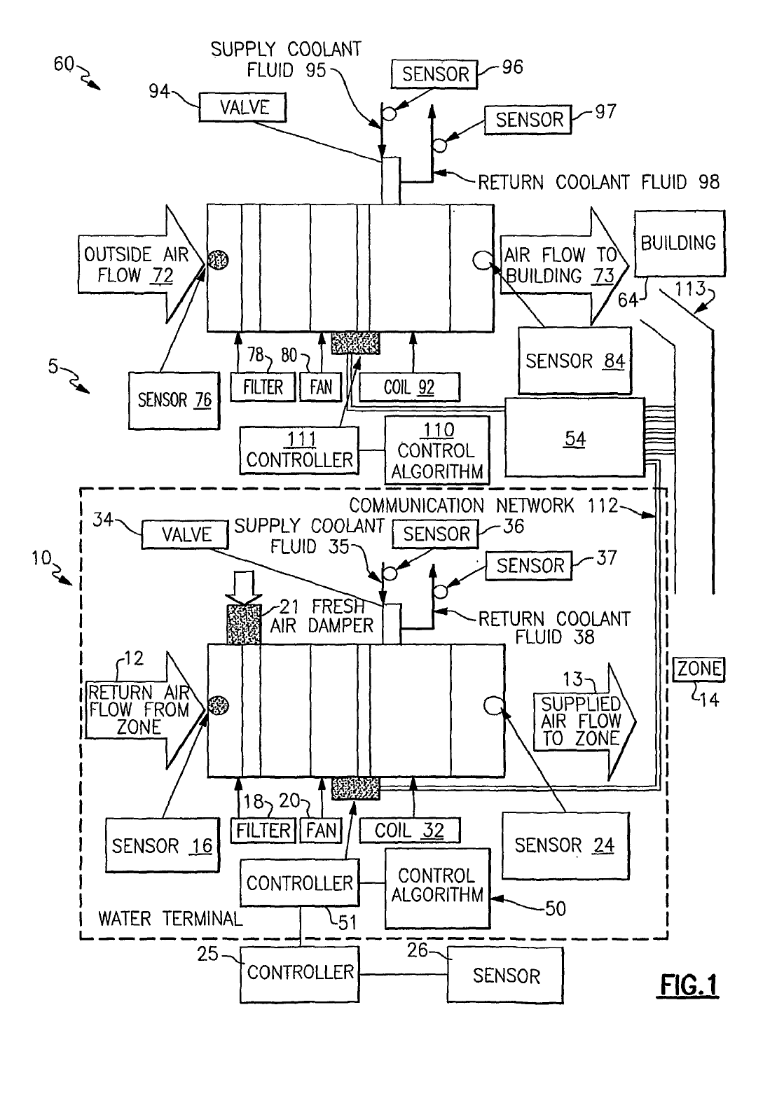

Referring initially to FIG. 1, there is illustrated a diagrammatical depiction of a building air-conditioning system generally referenced at 5, for conditioning the air of a building 64, wherein the air handling unit generally referenced at 60, the exemplary water terminal generally referenced at 10, equipped with a fresh air damper 21, the building air-conditioning system communication network 112, and the building fresh air duct network 113, comprise the major components of the system.

The air handling unit 60, is illustrated with a direction of outside air flow 72, coming into it from outdoors, and a direction of air exiting the air handling unit 60, as air flow 73, to the building 64. Outside air flow 72, entering the air handling unit 60, passes over an outside air temperature sensor 76, then through an air handling unit filter 78, at least one air handling unit fan 80, an air handling unit temperature adjusting coil 92, and finally over an air handling unit supply air temperature sensor 84.

An air handling unit supply side proportional coolant fluid flow valve 94, is disposed in the piping that the supplies the air handling unit supply coolant fluid 95, to the supply side of the air handling unit air temperature adjusting coil 92. The temperature of the air handling unit supply coolant fluid 95, is monitored by an air handling unit supply coolant fluid temperature sensor 96. The temperature of the air handling unit return coolant fluid 98, from the air handling unit air temperature adjusting coil 92, is monitored by an air handling unit return coolant fluid temperature sensor 97.

Also shown is an air handling unit controller 111, which runs an air handling unit control algorithm 110, that communicates with a building management system 54, through a building air-conditioning system communication network 112. The building air-conditioning system communication network 112, can be hard wired or wireless, and may or may not include a building management system.

As shown in FIG. 1, a building management system 54, uses the building air-conditioning system communication network 112, to communicate with numerous air-conditioning system components. FIG. 1 depicts exemplary component communications between an air handling unit controller 111, a building management system 54, and a water terminal controller 51, which is used to control a local zone water terminal generally shown at 10.

The water terminal controller 51, that executes the water terminal control algorithm 50, contains a microprocessor having a clock speed of at least 16 MHz, internal RAM memory of at least 3.84 Kbytes, internal FLASH memory of at least 128 Kbytes, internal E² memory of at least 1 K Byte, a built in A/D converter of at least 10 bits with a 1 LSB error, and a watchdog that is on chip hardware.

Local zone water terminal 10, provide air-conditioning for a zone 14, in the air conditioned building 64. In this example, where the air handler unit controller 111, the building management system 54, and the water terminal controller 51, are all communicating on the building air-conditioning system communication network 112, any data input by a building management system user or collected by any sensor on any of these components can be communicated to any of the other components according to their need for the data.

Turning now to the lower portion of FIG. 1, there is illustrated a diagrammatical depiction of local zone water terminal generally referenced at 10, that illustrates a direction of air flow coming into the system 12, from the air-conditioned zone 14, or fresh air duct with damper 21, and a direction of conditioned air flow exiting the system 13. Entrance of the air flow from the zone 14, or fresh air damper 21, passes over a return air temperature sensor 16, then through a supply side filter 18, at least one supply side air fan 20, a supply side air temperature adjusting coil 32, and finally over a supply air temperature sensor 24. The conditioned air is then supplied to the zone 14. The air in the zone 14, is monitored by carbon dioxide sensor 26, which is connected to a carbon dioxide controller 25, that is capable of providing signals to the water terminal controller 51, to determine the occupancy status of the zone 14.

A supply side proportional coolant fluid flow valve 34 is disposed in the piping that the supplies the supply coolant fluid 35 to the supply side of the air temperature adjusting coil 32. The temperature of the supply coolant fluid 35 is monitored by a supply coolant fluid temperature sensor 36. The temperature of the return coolant fluid 38, from the air temperature adjusting coil 32 is monitored by a return coolant fluid temperature sensor 37.

Free Cooling is a air-conditioning system control scheme wherein energy savings are achieved by reducing the speeds of the local water terminal cooling fans 20, and disabling the thermal pre-treatment functions of the air handling units 60, to allow outside air 72, to pass directly through the air handlers 60, the building fresh air duct network 113, and fresh air damper 21, of the local water terminal 10, that can locally condition the air with only minor temperature adjustments as necessary to provide the desired air-conditioning to the zone 14.

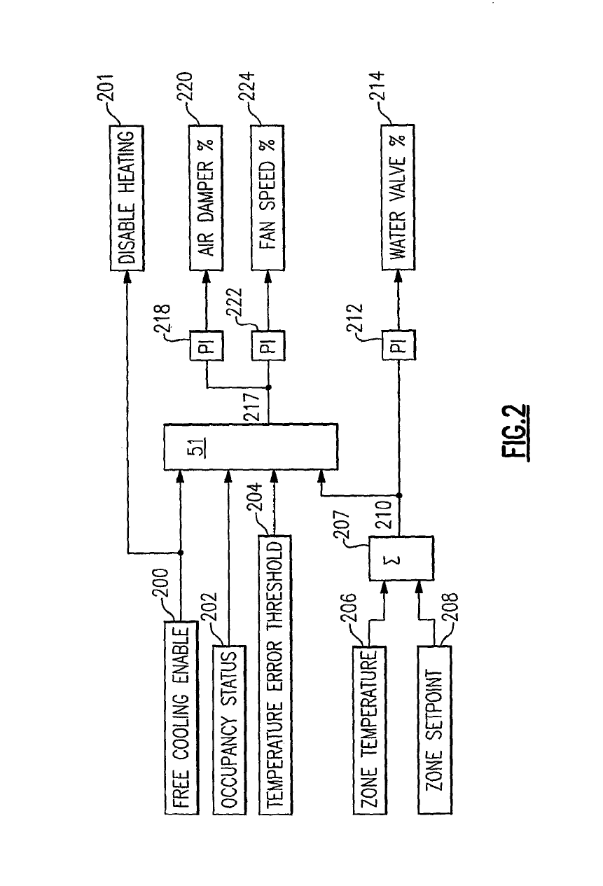

Turning now to FIG. 2, a block diagram of the new water terminal control algorithm 50, is provided which illustrates the various programmable and sensor signals to the water terminal controller 51, and signals to various mechanical components of the water terminal 10.

Most clearly relevant is the Free Cooling Enable Signal 200, to the water terminal controller 51, from a building management system 54, that continuously monitors the signal provided by the outside air temperature sensor 76. If the building management system determines that free cooling will be effective, it will enable the Free Cooling Enable Signal 200, in the water terminal controller 51. The next signal depicted in the block diagram is the Occupancy Status Signal 202 of the zone 14. This is sensed by a local carbon dioxide sensor 26, and communicated to the water terminal controller 51, by the carbon dioxide controller 25. The Occupancy Status Signal 202, is used to determine the mode, occupied or unoccupied, of free cooling to run when a Free Cooling Enable Signal 200, is received by the water terminal controller 51.

The next signal to the water terminal controller 51, is a user programmable Temperature Error Threshold Signal 204. Finally, there is a Local Temperature Error Point Signal 210, which is the resultant value of the combination in symbolic sigma block 207, that combines the values of the zone temperature 206, and the zone setpoint 208.

The Heating System Enable Variable 201, is controlled outside the new water terminal control algorithm 50, and is directly based on the Free Cooling Enable Signal 200. If the Free Cooling Enable Signal 200, is enabled by the building management system 54, the Heating System Enable Mode 201, is disabled. Additionally, if the Free Cooling Enable Signal 200, is enabled by the building management system 54, the Proportional Coolant Fluid Valve Percent Opening signal 214, is simply generated by the Local Temperature Error Point Signal 210, after it passes through the PI block 212, for conditioning thereby placing the valve in a simple proportional-integral control loop depending on the zone local temperature error.

Water terminal control algorithm 50, takes the aforementioned signals and logically processes them to yield a Fresh Air Damper and Cooling Fan signal 217, which is separately conditioned through PI block 218, to generate an Air Damper Percent Opening Signal 220, and through PI block 222, to generate a Cooling Fan Percent Speed Signal 224. When free cooling mode is enabled, the fresh air damper 21, will be fully opened to intake as much air from the air handling unit 60, as possible.

If in the occupied mode, the speed of the water terminal cooling fans 20, is minimized. In unoccupied mode, the speed of the water terminal cooling fans 20, is also minimized unless the Zone Temperature 206, is greater than the user programmable Temperature Error Threshold Signal 204, at which point the speed of the water terminal cooling fans 20, will be set to an automatic mode to until the local water terminal 10, reduces the zone temperature 206, to a point below the user programmable Temperature Error Threshold Signal 204.

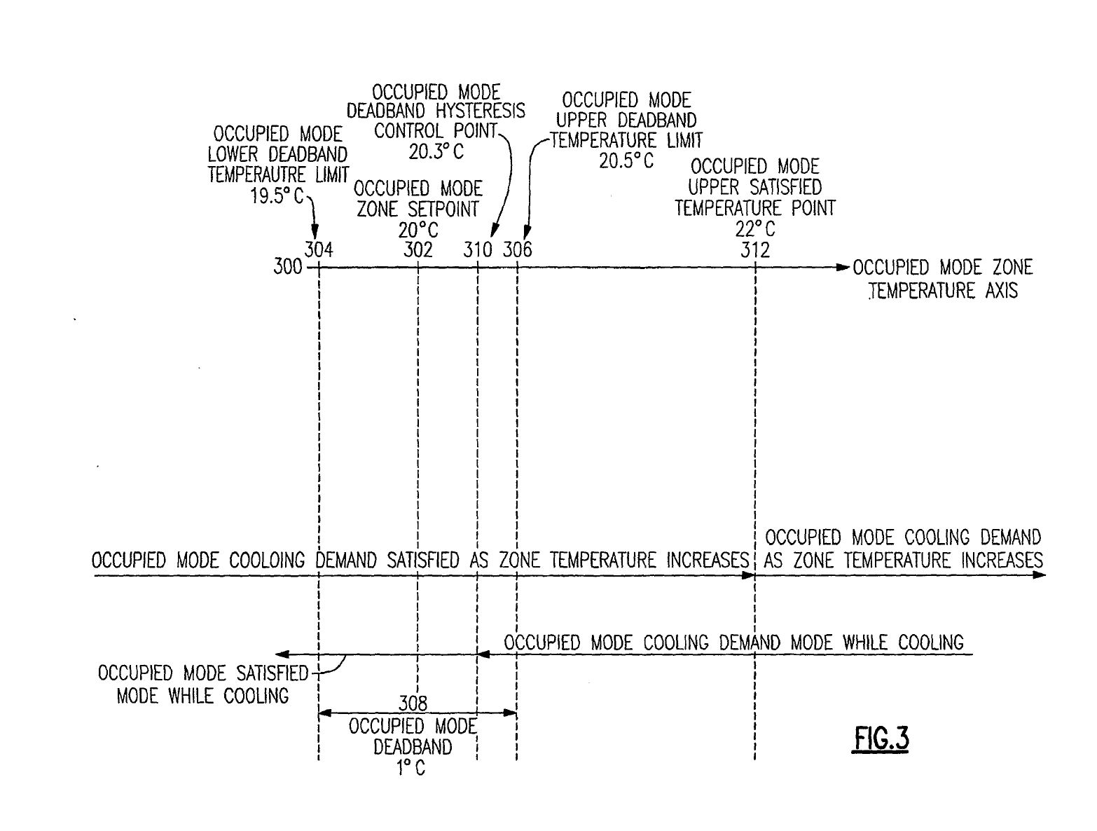

Turning the FIG. 3, there is an exemplary graphical depiction of the operation of the water terminal control algorithm 50, implementing free cooling in the occupied mode. An axis of the graph is depicted as the zone temperature 206, increases moving from left to right along the axis 300.

While various Occupied Mode Zone Setpoints 302, and Occupied Mode Deadbands 308, may be selected based on a particular application, the calculation and determination of resultant control points by the control algorithm remains the same.

In FIG. 3, an Occupied Mode Zone Setpoint 302, is shown to be 20 degrees Celsius, an Occupied Mode Lower Deadband Temperature Limit 304, is shown to be 19.5 degrees Celsius, and an Occupied Mode Upper Deadband Temperature Limit 306, is shown to be 20.5 degrees Celsius, to yield an Occupied Mode Deadband 308, which in this case, is 1.0 degree Celsius, about the Occupied Mode Zone Setpoint 302. The overall function of the air handling unit 60, is to provide fresh air to ensure that the local water terminal can maintain their zone 14, temperature within Occupied Mode Deadband 308.

Within the Occupied Mode Deadband 308, is a control point that implements a 0.2 degree Celsius Occupied Mode Deadband Hysteresis Control Point 310. This value is calculated using the Occupied Mode Zone Setpoint 302, plus one half of the Occupied Mode Deadband 306, minus 0.2 degrees Celsius.

When the zone temperature 206, is being reduced to any temperature below the Occupied Mode Hysteresis Control Point 310, or is being increased to the Occupied Mode Upper Satisfied Temperature Point 312, which is calculated by adding the zone setpoint 302, plus the deadband 308 plus 1 degree Celsius, to the Occupied Mode Upper Satisfied Temperature Limit 312, in this case 22 degrees Celsius, the control algorithm 50, determines that the occupied mode cooling demand is satisfied. In all other instances, the control algorithm 50, determines that the system is in cooling demand mode.

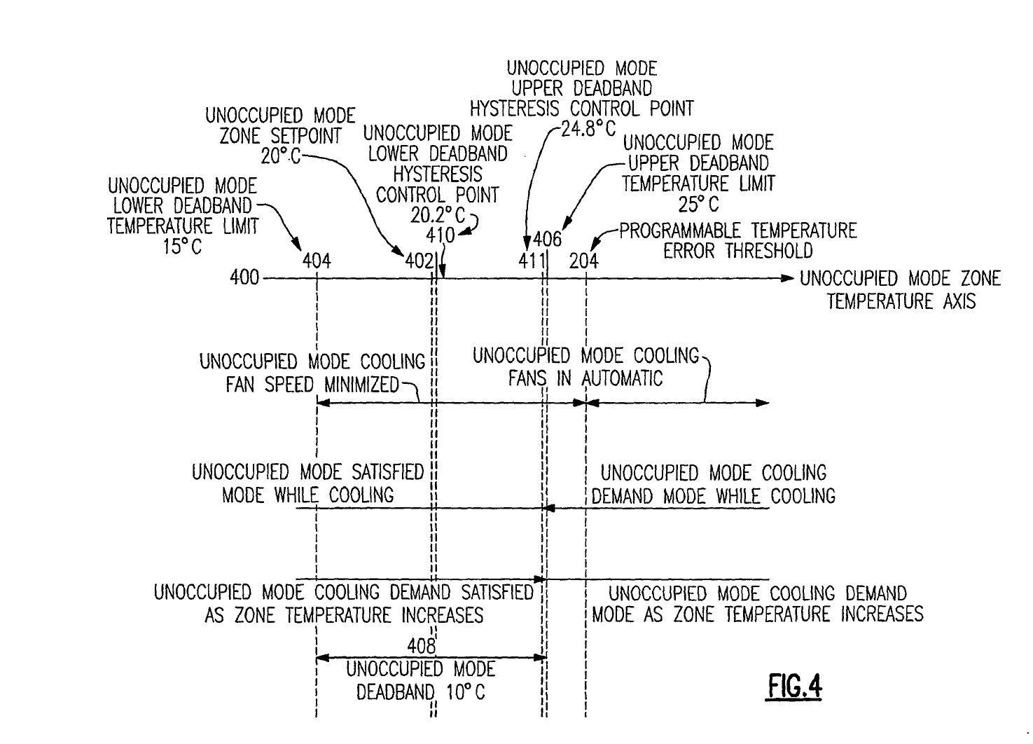

Turning the FIG. 4, there is an exemplary graphical depiction of the operation of the water terminal control algorithm 50, implementing free cooling in the unoccupied mode. An axis of the graph is depicted as the zone temperature 206, increases moving from left to right along the axis 400.

While various Unoccupied Mode Zone Setpoints 402, and Unoccupied Mode Deadbands 408, may be selected based on a particular application, the calculations and determination of resultant control points by the control algorithm remains the same.

In FIG. 4, an Unoccupied Mode Zone Setpoint 402, is shown to be 20 degrees Celsius, an Unoccupied Mode Lower Deadband Temperature Limit 404, is shown to be 15 degrees Celsius, and an Unoccupied Mode Upper Deadband Temperature Limit 406, is shown to be 25 degrees Celsius, to yield an Unoccupied Mode Deadband 408, in this case, 10 degrees Celsius, about the Unoccupied Mode Zone Setpoint 402. The overall function of the air handling unit 60, is to provide fresh air to ensure that the local water terminal can maintain their zone temperature 206, within Deadband 408.

Within the Unoccupied Mode Deadband 408, is a control point that implements a 0.2 degree Celsius lower Unoccupied Mode Deadband Hysteresis Control Point 410. This value is calculated by adding 0.2 degrees Celsius to the Unoccupied Mode Zone Setpoint 402.

Also within the Unoccupied Mode Deadband 408, is an Unoccupied Mode Upper Deadband Hysteresis Control Point 411, that is calculated by adding the zone setpoint 402, plus one half of the Unoccupied Mode Upper Deadband Temperature Limit 406, and subtracting 0.2 degrees Celsius for a result, in this case, of 24.8 degrees Celsius.

When the zone temperature 206, is being reduced to any temperature below the Unoccupied Mode Upper Hysteresis Control Point 411, or is being increased to the Unoccupied Mode Upper Deadband Temperature Limit 406, the control algorithm 50, determines that the cooling demand is satisfied. In all other instances, the control algorithm 50, determines that the system is in cooling demand mode.

As noted above, in unoccupied mode, the speed of the water terminal cooling fans 20, are minimized unless the zone temperature 206, is above the programmable Temperature Error Threshold Signal 204, at which point the speed of the water terminal cooling fans 20, will be set to an automatic mode to allow them to reduce the zone temperature 206, below the programmable Temperature Error Threshold Signal 204.

Pre-Free Cooling, used in the unoccupied mode, is an air-conditioning control scheme where the desired fresh air 73, for cooling a zone 14, is lower than the outside air 72, temperature, zone temperature 206, is higher than the outside air 72, so pushing non-conditioned outside air 72, into the system can still yield significant building temperature reduction without having to use the air-conditioning component of the air handling unit 60. This will be effective until the outside air 72, brings the building to as low a temperature as possible, equal to the outside temperature, at which point the air-conditioning components of the air handling unit 60, and water terminals 10, will need to be activated to finish the cooling to the desired zone temperature setpoint 208.

Much in the same way as Free Cooling and Pre-Free Cooling are implemented using outside air, Free-Heating is contemplated a variation of these aforementioned air-conditioning control schemes.

While the present invention has been particularly shown and described with reference to the preferred mode as illustrated in the drawing, it will be understood by one skilled in the art that various changes in detail may be effected therein without departing from the spirit and scope of the invention as defined by the claims.

We claim:

1. A method to create energy savings in a local zone water terminal of an air-conditioning system of the type having a building management system comprising the steps of:
obtaining a signal from said building management system to enable a free cooling mode of operation; and
responsively opening a fresh air damper of said local zone water terminal to a fully open position.

2. The method of claim 1 further comprising the steps of:
responsively disabling a heating mode of said local zone water terminal.

3. The method of claim 1 further comprising the steps of:
obtaining a zone temperature;
obtaining a zone temperature setpoint;
comparing said zone temperature with said zone temperature setpoint to obtain a local temperature error.

4. The method of claim 3 further comprising the steps of:
responsively operating a local zone proportional coolant fluid flow control valve in a proportional-integral control loop depending on said local temperature error.

5. The method of claim 1 further comprising the steps of:
determining that said local zone is occupied; and
responsively minimizing the speed of at least one cooling fan of said local zone water terminal.

6. The method of claim 5 further comprising the steps of
obtaining a zone temperature;
obtaining a zone temperature setpoint;
obtaining an occupied mode zone temperature control deadband;
determining an occupied mode lower deadband temperature limit;
determining an occupied mode upper deadband temperature limit;
determining an occupied mode deadband hysteresis control point; and
determining an occupied mode upper satisfied temperature limit.

7. The method of claim 6 further comprising the steps of:
determining whether said zone temperature is being reduced or increased.

8. The method of claim 7 further comprising the steps of:
determining that said zone temperature is being reduced; and
changing from cooling demand mode to cooling satisfied mode as the temperature reduces to said occupied mode deadband hysteresis control point.

9. The method of claim 7 further comprising the steps of:
determining that said zone temperature is being increased; and
changing from cooling satisfied mode to cooling demand mode as the temperature rises to said occupied mode upper satisfied temperature point.

10. The method of claim 1 further comprising the steps of:
determining that said local zone is unoccupied;
obtaining a zone temperature and;
obtaining a temperature threshold value.

11. The method of claim 10 further comprising the steps of:
comparing said zone temperature with said local air temperature threshold value;
determining that said local air temperature is lower than said temperature threshold; and
responsively minimizing the speed of at least one cooling fan of said local zone water terminal.

12. The method of claim 10 further comprising the steps of:
comparing said zone temperature with said local air temperature threshold value;
determining that said zone temperature is higher than said local air temperature threshold; and
responsively controlling the speed of at least one of said cooling fans of said local zone water terminal in an automatic mode.

13. The method of claim 10 further comprising the steps of
obtaining a zone temperature;
obtaining a zone temperature setpoint;
obtaining an unoccupied mode zone temperature control deadband;
determining an unoccupied mode lower deadband temperature limit;
determining an unoccupied mode upper deadband temperature limit;
determining an unoccupied mode lower deadband hysteresis control point;
and;
determining an unoccupied mode upper deadband hysteresis control point.

14. The method of claim 13 further comprising the steps of:
determining whether said zone temperature is being reduced or increased.

15. The method of claim 14 further comprising the steps of:
determining that said zone temperature is being reduced; and
responsively changing from cooling demand mode to cooling satisfied mode as the temperature reduces to the unoccupied mode deadband hysteresis control point.

16. The method of claim 14 further comprising the steps of
determining that said zone temperature is being increased; and
changing from cooling satisfied mode to cooling demand mode as the temperature rises to the unoccupied mode upper deadband temperature limit.
